(19) United States
(12) Patent Application Publication
(10) Pub. No.: US 2025/0332947 A1
(43) Pub. Date: Oct. 30, 2025

(54) BATTERY AND VEHICLE

(71) Applicant: TOYOTA JIDOSHA KABUSHIKI KAISHA, Toyota-shi (JP)

(72) Inventors: Tsubasa MIGITA, Sakai-shi (JP); Taro MATSUSHITA, Toyokawa-shi (JP); Yasuhiro KURODA, Toyota-shi (JP); Aki UOTANI, Nagoya-shi (JP); Shinji ICHIKAWA, Nagoya-shi (JP); Shuta ITO, Toyota-shi (JP)

(73) Assignee: TOYOTA JIDOSHA KABUSHIKI KAISHA, Toyota-shi (JP)

(21) Appl. No.: 19/034,858

(22) Filed: Jan. 23, 2025

(30) Foreign Application Priority Data
Apr. 25, 2024 (JP) 2024-071066

(51) Int. Cl. B60L 53/80; B60L 50/60; B60L 53/66

(52) U.S. Cl. CPC B60L 53/80; B60L 50/60; B60L 53/66; B60L 2240/54

(57) ABSTRACT

A battery is a swappable battery for driving an electrified vehicle. Charging of the battery is not started until a specific time (for example, elimination time, certain time) elapses from when the battery is connected to the charging device after being removed from the electrified vehicle. Thus, even when the battery is connected to the charging device after being removed from the electrified vehicle, the charging of the battery is not started until the specific time elapses. The specific time may be a time until high-rate degradation is eliminated. The high-rate degradation is a state in which the battery has an increased internal resistance due to an uneven lithium-ion concentration distribution in an electrolyte solution of the battery caused by charging or discharging including charging or discharging performed at a current value higher than a predetermined current value when the battery is connected to the electrified vehicle.

### CROSS-REFERENCE TO RELATED APPLICATION

This application claims priority to Japanese Patent Application No. 2024-071066 filed on Apr. 25, 2024, incorporated herein by reference in its entirety.

### BACKGROUND

### 1. Technical Field

The present disclosure relates to batteries and vehicles, and more particularly to a battery that is swappable and configured to drive a vehicle and a vehicle on which this battery is mountable.

### 2. Description of Related Art

Conventionally, there has been a system that shares swappable batteries for driving a vehicle (see, for example, Japanese Unexamined Patent Application Publication No. 2020-190480 (JP 2020-190480 A)).

### SUMMARY

In terms of reducing battery degradation, there is room for improvement in control that is performed when charging a swapped-out battery with a charging device in a battery swap facility.

The present disclosure was made to solve the above issue, and an object of the present disclosure is to provide a battery and a vehicle that can reduce degradation of the battery.

A battery according to one aspect of the present disclosure is a battery that is swappable and that is configured to drive a vehicle. Charging of the battery is not started until a specific time elapses from when the battery is connected to a charging device after the battery is removed from the vehicle.

With such a configuration, even when the battery is connected to the charging device after being removed from the vehicle, the charging of the battery is not started until the specific time elapses. It is therefore possible to provide a battery that can reduce degradation of the battery.

The specific time may be a time until high-rate degradation is eliminated. The high-rate degradation is a state in which the battery has an increased internal resistance due to an uneven lithium-ion concentration distribution in an electrolyte solution of the battery caused by charging or discharging including charging or discharging performed at a current value higher than a predetermined current value when the battery is connected to the vehicle.

With such a configuration, even when the battery is connected to the charging device after being removed from the vehicle, the charging of the battery is not started until the time it takes for the high-rate degradation to be eliminated elapses, namely until the battery is no longer in the state in which the battery has an increased internal resistance due to an uneven lithium-ion concentration distribution in the electrolyte solution of the battery caused by charging or discharging including charging or discharging performed at a current value higher than the predetermined current value when the battery is connected to the vehicle. It is therefore possible to reduce degradation of the battery due to the high-rate degradation.

The charging device may be configured not to start the charging of the battery until the specific time elapses, even when the battery is connected to the charging device.

With such a configuration, even when the battery is connected to the charging device after the battery is removed from the vehicle, the charging of the battery is not started until the specific time elapses. Degradation of the battery can thus be reduced by the charging device.

The battery may include a timer configured to measure a remaining time left until the specific time elapses, and the charging of the battery may not be started until the remaining time measured by the timer becomes less than a predetermined time.

With such a configuration, even when the battery is connected to the charging device after the battery is removed from the vehicle, the charging of the battery is not started until the remaining time left until the specific time elapses as measured by the timer becomes less than the predetermined time. Degradation of the battery can thus be reduced by the timer.

A vehicle according to another aspect of the present disclosure is a vehicle on which the above battery is mountable. The vehicle includes a communication unit configured to send the remaining time measured by the timer to a server. The server is configured to communicate with the charging device configured to charge the battery removed from the vehicle.

With such a configuration, it is possible to provide a vehicle that can reduce degradation of a battery.

The present disclosure can provide a battery and a vehicle that can reduce degradation of the battery.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a battery swap system including an electrified vehicle according to an embodiment of the present disclosure;

FIG. 2 is a diagram showing the configuration of electrified vehicle of this embodiment;

FIG. 3 is a flowchart illustrating a flow of a battery charging process according to the first embodiment;

FIG. 4 is a flow chart showing a flow of a battery-charging process according to the second embodiment; and

FIG. 5 is a flowchart illustrating a flow of a battery charging process according to the third embodiment.

### DETAILED DESCRIPTION OF EMBODIMENTS

Hereinafter, embodiments of the present disclosure will be described in detail with reference to the drawings. It should be noted that the same or corresponding portions in the drawings are designated by the same reference signs and repetitive description will be omitted.

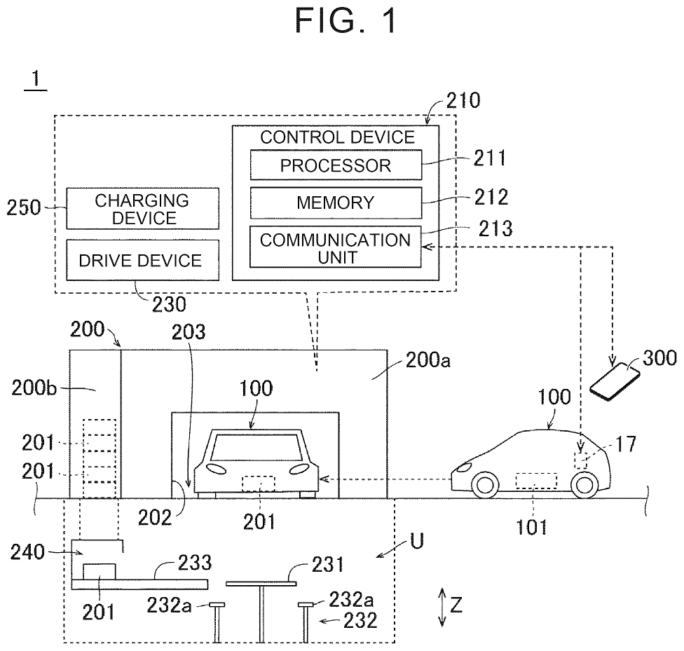

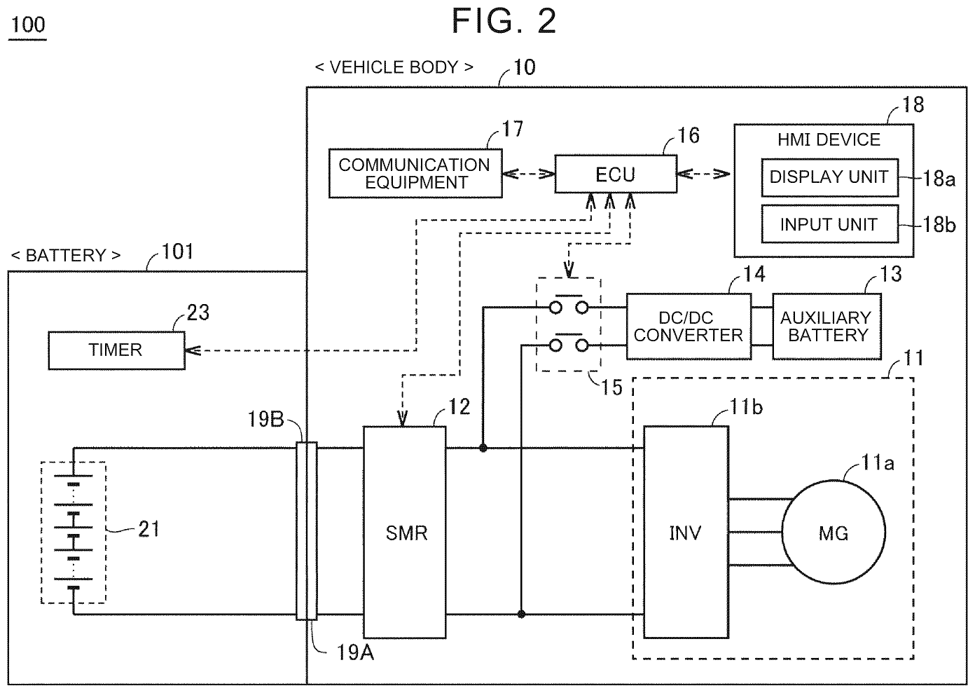

FIG. 1 shows a battery swap system 1 including an electrified vehicle 100 according to an embodiment of the present disclosure. FIG. 2 is a diagram illustrating a configuration of an electrified vehicle 100 according to the present embodiment. Referring to FIGS. 1 and 2, the Z direction illustrated in FIG. 1 indicates a moving direction of a battery placement table 231 to be described later.

The battery swap system 1 includes an electrified vehicle 100 and a battery swap station 200.

Electrified vehicle 100 includes a vehicle body 10 and a battery 101. Electrified vehicle 100 is, for example, a battery electric vehicle (BEV without an internal combustion engine.

The vehicle body 10 is a part of electrified vehicle 100 other than the battery 101. The vehicle body 10 includes a vehicle drive unit 11, a System Main Relay (SMR) 12, an auxiliary battery 13, a direct current-to-direct current (DC/DC) converter 14, a relay 15, an Electronic Control Unit (ECU) 16, a communication device 17, a Human Machine Interface (HMI) device 18, and a terminal 19A. The terminal 19A is formed to be electrically connectable to a terminal 19B formed in the battery 101. The vehicle body 10 is formed to be electrically connectable to the battery 101 via a terminal 19A, 19B.

The vehicle drive unit 11 includes a motor generator (MG) 11a and an inverter 11b. The vehicle drive unit 11 is configured to drive electrified vehicle 100 by using the electric power output from the battery 101.

MG 11a functions as a driving motor. MG 11a is electrically connected to the battery 101 via an inverter 11b. MG 11a converts power from the battery 101 into torques to rotate the drive wheels of electrified vehicle 100. Further, MG 11a performs regenerative power generation, for example, at the time of deceleration of electrified vehicle 100, and charges the battery 101.

The inverter 11b functions as a Power Control Unit (PCU) for MG 11a. The inverter 11b drives MG 11a using the electric power supplied from the battery 101.

SMR 12 functions as an on-off switch of the electric circuitry between the inverter 11b and the battery 101 in accordance with instructions from ECU 16. SMR 12 is provided between the inverter 11b and the battery 101.

The auxiliary battery 13 supplies electric power for driving the auxiliary devices mounted on electrified vehicle 100, for example, the communication device 17, ECU 16, and HMI device 18. The auxiliary battery 13 is connected to a wire connecting the inverter 11b and SMR 12 via DC/DC converter 14.

DC/DC converter 14 boosts the DC current supplied from the auxiliary battery 13 to MG 11a and supplies the boosted DC current to the inverter 11b. DC/DC converter 14 are provided between wires connecting the auxiliary battery 13, SMR 12, and the inverter 11b.

The relay 15 functions as an on-off switch of the electric circuit between the auxiliary battery 13 and the inverter 11b in accordance with an instruction from ECU 16. The relay 15 is provided between DC/DC converter 14 and the wires connecting SMR 12 and the inverter 11b.

ECU 16 includes a processor and a memory. The processor controls the respective devices of electrified vehicle 100 based on information recorded in the memories and information acquired through a communication device 17 or the like which will be described later. ECU 16 is communicably connected to the devices (SMR 12, relay 15, communication device 17, HMI devices 18, and timers 23) via an in-vehicle network (e.g., a Controller Area Network (CAN)).

The communication device 17 is an interface for communicating with a device outside the vehicle (the control device 210 of the battery swap station 200, the mobile terminal 300, and the like) via a network. The communication device 17 transmits information transmitted from ECU 16 to a device outside the vehicle, or transmits information received from a device outside the vehicle to ECU 16.

HMI device 18 includes a display unit 18a and an input unit 18b provided in the vehicle cabin. HMI device 18 may include a touch panel display. The input unit 18b may be a hard key provided in the display unit 18a or may be operated on a touch panel display. HMI device 18 outputs a signal corresponding to an input to the input unit 18b by the user to ECU 16.

The battery 101 includes a battery 21, a timer 23, and a terminal 19B. The battery 21 is a secondary battery, for example, a lithium-ion battery, but is not limited thereto, and may be a nickel metal hydride battery or a sodium-ion battery. The type of the secondary battery may be a liquid secondary battery or an all-solid secondary battery. The battery 21 is formed to be electrically connectable to the vehicle body 10 by connecting the terminal 19A and the terminal 19B.

The timer 23 includes a processor and a memory. The processor executes a predetermined process based on information recorded in the memories and information acquired from ECU 16. The timer 23 is communicatively connected to ECU 16 via an in-vehicle network (e.g., a Controller Area Network (CAN). The configuration of the battery 201, which will be described later, is also the same as the configuration of the battery 101.

The battery swap station 200 includes a battery swap station body 200a in which battery swapping is performed, and a storage 200b in which a plurality of batteries 201 can be stored. The battery swap station body 200a is a device that performs battery swapping for swapping the battery 101 mounted on electrified vehicle 100 out with the battery 201. The storage 200b is provided in the body 200a of the battery swap station. The battery swap station 200 (battery swap station body 200a) is provided with an entrance 202 for electrified vehicle 100 to enter and leave the battery swap station 200.

The battery swap station 200 (battery swap station body 200a) includes a control device 210, a drive device 230, and a charging device 250.

The control device 210 includes a processor 211, a memory 212, and a communication unit 213. The memory 212 stores a program to be executed by the processor 211 and information (for example, a map, a mathematical expression, and various parameters) used in the program. The memory 212 further stores battery information that is information about the battery shape, the battery arrangement direction, the voltage, the output power, and the capacity (remaining capacity) of each battery 201. The processor 211 controls the drive device 230 and the charging device 250.

The communication unit 213 includes various communication I/F. The processor 211 controls the communication unit 213. The communication unit 213 communicates with electrified vehicle 100 communication device 17. The communication unit 213 and electrified vehicle 100 (communication device 17) are capable of two-way communication. The communication unit 213 can also communicate with the mobile terminal 300 owned by the user of electrified vehicle 100.

The battery swap station 200 is provided with a vehicle stop area 203. In HMI device 18 of electrified vehicle 100, when electrified vehicle 100 is stopped in the vehicle stop area 203, an operation for instructing the start of the battery swap work may be performed by the user. In this case, ECU 16 of electrified vehicle 100 transmits an instruction signal for starting the battery-changing operation from the communication device 17 to the communication unit 213 of the control device 210. The processor 211 of the control device 210 starts the control of the battery swap work by the drive device 230 based on the reception of the instruction signal by the communication unit 213.

The drive device 230 includes a battery placement table 231, a lifting unit 232, and a transport unit 233. In the underfloor region U of the battery swap station 200, a battery placement table 231, a lifting unit 232, a transport unit 233, and a temporary storage space 240 are provided. The lifting unit 232 raises and lowers electrified vehicle 100 while holding electrified vehicle 100 from below. The lifting unit 232 includes a pair of lifting bars 232a. Electrified vehicle 100 is supported from below by a pair of lifting bars 232a. Battery swapping (removal and mounting of batteries) is performed while electrified vehicle 100 is held horizontally by a pair of lifting bars 232a.

The battery placement table 231 is configured to be movable up and down in the Z direction. When the battery placement table 231 is raised to the height position of the bottom of electrified vehicle 100, the battery 101 removed from electrified vehicle 100 is placed on the battery placement table 231. Further, the battery placement table 231 on which the battery 201 is placed is raised to the height position of the bottom of electrified vehicle 100, whereby the battery 201 is attached to electrified vehicle 100.

The transport unit 233 is configured to transport the batteries 101, 201. Specifically, the transport unit 233 transports the battery 101 removed from electrified vehicle 100 and placed on the battery placement table 231 to the temporary storage space 240. Further, the transport unit 233 transports the battery 201 transported from the storage 200b to the temporary storage space 240 to the battery placement table 231.

The charging device 250 transports the charged battery 201 from the storage 200b to the temporary storage space 240. In addition, the charging device 250 transports the battery 101 removed from electrified vehicle 100 from the temporary storage space 240 to the storage 200b, and connects a connector for charging to the terminal 19B.

In terms of reducing degradation of the battery 201, the above battery swap system 1 has room for improvement in control that is performed when charging a swapped-out battery 201 with the charging device 250.

Therefore, charging of the swappable battery 101 configured to drive the electrified vehicle 100 is not started until a specific time elapses from when the battery 101 is connected to the charging device 250 after being removed from the electrified vehicle 100.

Thus, even when the battery 101 is connected to the charging device 250 after being removed from electrified vehicle 100, the charging of the battery 101 is not started until a specific time elapses. As a result, degradation of the battery 101 can be suppressed.

The battery 101 may go into the state of high-rate degradation in which the battery 101 has an increased internal resistance due to an uneven concentration distribution of ions such as lithium ions in an electrolyte solution of the battery 101 caused by charging or discharging including charging or discharging performed at a current value higher than a predetermined current value when the battery 101 is connected to the electrified vehicle 100. The predetermined current value is, for example, a predetermined C-rate between 5 and 10C. The C rate is the magnitude of the current when the battery 101 is energized. 1C is a current that is completely discharged in one hour when the battery is discharged from a fully charged state. Charging and discharging at a current value higher than the predetermined current value are called high-rate charging and high-rate discharging, respectively. The longer the charging or discharging at a relatively high current value such as high-rate charging or high-rate discharging is continued, the worse the high-rate degradation becomes. The state of high-rate degradation is a state of reversible degradation. For example, the high-rate degradation is eliminated by not performing charging or discharging for a time corresponding to the degree of the high-rate degradation or by setting the current value for charging or discharging to less than the predetermined current value. The high-rate degradation caused by charging is eliminated by discharging. The high-rate degradation caused by discharge is eliminated by charging. When charging or discharging is continued in the state of high-rate degradation or when charging is continued at a current value higher than the predetermined current value, the battery 101 irreversibly degrades, for example, electrodeposition in which lithium metal is deposited on the negative electrode occurs.

### First Embodiment

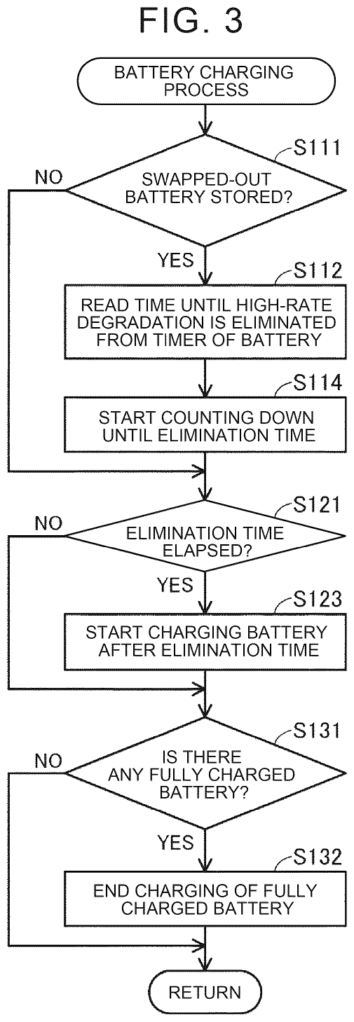

FIG. 3 is a flowchart illustrating a flow of a battery charging process according to the first embodiment. Referring to FIG. 3, the battery charging process is called from the higher-order process at every predetermined cycle by the processor 211 of the control device 210 of the charging device 250 and is executed.

The processor 211 of the control device 210 determines whether the swapped-out battery 101 is stored in the storage 200b and the charging connector of the charging device 250 is connected to the terminal 19B of the battery 101 (S111).

When it is determined that the battery 101 is stored (YES in S111), the processor 211 reads from the timer 23 of the battery 101 the elimination time until the high-rate degradation is eliminated, and stores the elimination time in the memory 212 (S112).

The elimination time is calculated from the history of the current values of the battery 21 by ECU 16 of electrified vehicle 100 when the battery 101 is connected to electrified vehicle 100. For example, a map indicating a correspondence relationship between the cumulative value of the current and the elimination time is created in advance. The integrated value of the current is calculated from the history of the current values, and the elimination time corresponding to the calculated cumulative value is read from the map, whereby the elimination time is calculated. This elimination time is calculated at predetermined cycles, and the calculated elimination time is updated and stored in the timer 23 each time. The timer 23 continues to subtract the time elapsed from the stored elimination time, and constantly subtracts and updates the elimination time. The timer 23 subtracts and updates the elimination time not only when the battery 101 is connected to the electrified vehicle 100 but also after the battery 101 is removed from the electrified vehicle 100.

The processor 211 then starts counting down the elimination time stored in the memory 212 (S114). The value of the countdown in the control device 210 is basically the same as the value of the countdown in the timer 23 of the battery 101. For this reason, the control device 210 may not perform the countdown, and read the elimination time from the timer 23 of the battery 101 each time.

If it is determined that the battery 101 is not at the stored timing (NO in S111), or after S114, the processor 211 determines whether there is a battery 101 out of the stored batteries 101 in which the elimination time has elapsed (S121). If it is determined that there is a battery 101 in which the elimination time has elapsed (YES in S121), the processor 211 controls the charging device 250 to start charging of the battery 101 in which the elimination time has elapsed (S123).

If it is determined that there is no battery 101 in which the elimination time has elapsed (NO in S121), or after step 123, the processor 211 determines whether there is a battery 101 that has become fully charged out of the stored batteries 101 (S131). If it is determined that there is a fully charged battery 101 (YES in S131), the processor 211 controls the charging device 250 to terminate the charging of the fully charged battery 101 (S132). When it is determined that there is no battery 101 that has been fully charged (NO in S131), or after S132, the processor 211 returns the process to be executed to the process of the upper level of the caller of the battery charging processing.

### Second Embodiment

In the first embodiment, the battery 101 is provided with the timer 23, and charging of the battery 101 is started after the elimination time stored in the timer 23 has elapsed. In the second embodiment, the battery 101 is not provided with the timer 23.

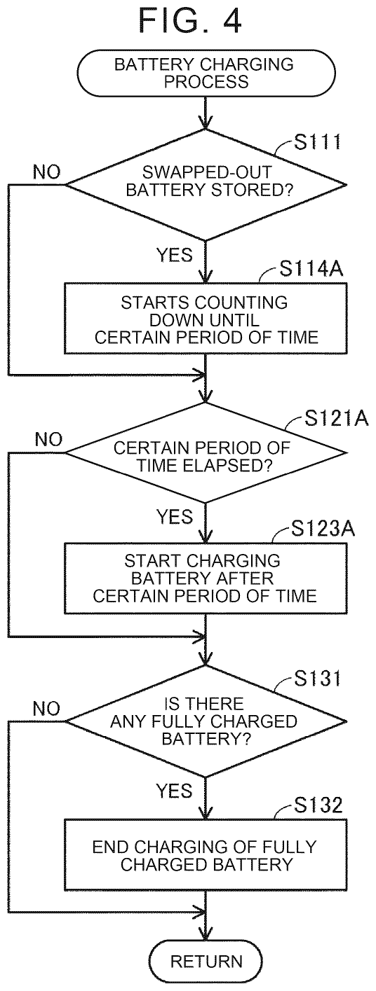

FIG. 4 is a flowchart illustrating a flow of a battery charging process according to the second embodiment. Referring to FIG. 4, the battery charging process is called from the higher-order process at every predetermined cycle by the processor 211 of the control device 210 of the charging device 250 and is executed. In FIG. 4 of the second embodiment, portions different from those in FIG. 3 of the first embodiment will be described, and redundant description will not be repeated.

If it is determined that the swapped-out battery 101 has been stored (YES in S111), the processor 211 starts counting down for a period of time that is long enough for the high-rate degradation to be eliminated (S114A). This fixed time period is a predetermined time period for each type of battery 101 that can be handled by the battery swap station 200, and is, for example, a representative value (for example, maximum value) of an elimination time of high-rate degradation for each type of battery 101.

If it is determined that the battery 101 is not at the stored timing (NO in S111), or after S114A, the processor 211 determines whether or not there is a battery 101 out of the stored batteries 101 for which a certain period of time has elapsed (S121A). If it is determined that there is a battery 101 in which a certain period of time has elapsed (YES in S121A), the processor 211 controls the charging device 250 to initiate charging of the battery 101 in which the certain period of time has elapsed (S123A).

### Third Embodiment

In the first embodiment, the control device 210 of the charging device 250 directly reads the elimination time from the timer 23 of the battery 101. In the third embodiment, the control device 210 of the charging device 250 communicates with electrified vehicle 100 to obtain the elimination time stored in the timer 23 of the battery 101.

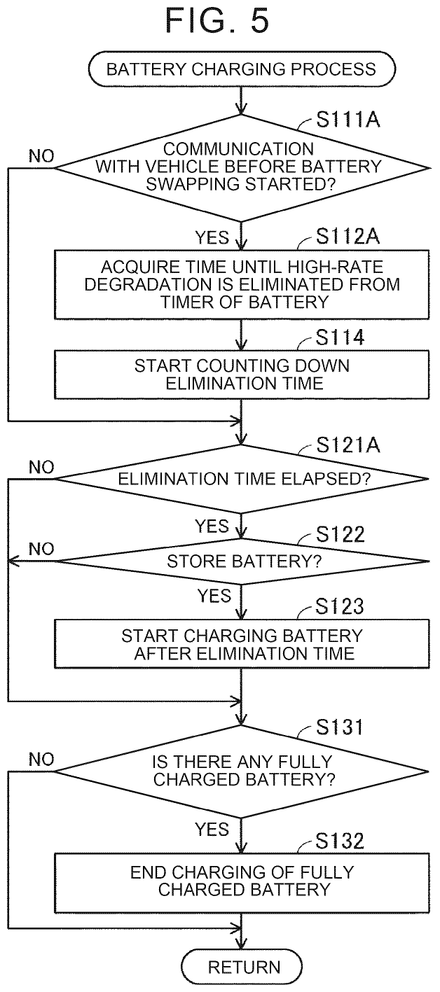

FIG. 5 is a flowchart illustrating a flow of a battery charging process according to the third embodiment. Referring to FIG. 5, the battery charging process is called from the higher-order process at every predetermined cycle by the processor 211 of the control device 210 of the charging device 250 and is executed. In FIG. 5 of the third embodiment, portions different from those in FIG. 3 of the first embodiment will be described, and redundant description will not be repeated.

The processor 211 of the control device 210 determines whether communication with electrified vehicle 100 before swapping of the battery 101 has been initiated (S111A). In the communication before swapping, for example, information such as the type and the number of batteries 101 to be swapped out and the waiting status of the battery swap station 200 is communicated.

If it is determined that the communication before swapping of the battery 101 is started (YES in S111A), the processor 211 controls the communication unit 213 so as to acquire an elimination time from the timer 23 of the battery 101 until the high-rate degradation is eliminated through the communication device 17 of the electrified vehicle 100. The acquired elimination time is stored in the memory 212 (S112A). The processor 211 then performs S114 of FIG. 3.

If it is determined that the communication before swapping of the battery 101 is not timed to be started (NO in S111A), or after S114, the processor 211 determines whether there is a battery 101 whose elimination time has elapsed (S121A). When it is determined that there is a battery 101 in which the elimination time has elapsed (YES in S121A), it is determined whether the battery 101 in which the elimination time has elapsed is stored in the storage 200b (S122). If it is determined that the battery 101 is stored (YES in S122), the processor 211 performs S123 of FIG. 3.

When it is determined that there is no battery 101 in which the elimination time has elapsed (NO in S121A), when it is determined that the battery 101 in which the elimination time has elapsed is not stored in the storage 200b (NO in S122A), or after step 123, the processor 211 performs S131 and the subsequent steps in FIG. 3.

### Modifications

(1) In the above embodiment, electrified vehicle 100 is BEV. However, the present disclosure is not limited thereto, and electrified vehicle 100 may be other types of vehicles, for example, hybrid electric vehicle (HEV), plug-in hybrid electric vehicle (PHEV), or fuel cell electric vehicle (FCEV).

(2) In the above embodiment, the number of batteries 101 mounted on electrified vehicle 100 is one. However, the present disclosure is not limited thereto, and the number of batteries 101 mounted on electrified vehicle 100 may be two or more.

(3) In the above embodiment, as illustrated in FIG. 2, SMR 12 is provided in the vehicle body 10, and the battery 101 is not provided with an SMR. However, the present disclosure is not limited thereto, and SMR may be provided in both the vehicle body and the battery, or SMR may be provided in the battery 101 while SMR is not provided in the vehicle body 10.

(4) The embodiments described above can be viewed as disclosing the battery 101, electrified vehicle 100, the battery swap station 200, the control device 210, or the charging device 250 illustrated in FIGS. 1 and 2. The present disclosure can be understood as a disclosure of a battery charging method or a battery charging program executed by these devices.

### SUMMARY

(1) As shown in FIGS. 1 and 2, the battery 101 is a swappable battery for driving an electrified vehicle 100. As shown in FIGS. 3 to 5, the charging of the battery 101 is not started until a specific time (for example, elimination time, certain time) elapses from when the battery 101 is connected to the charging device 250 after being removed from the electrified vehicle 100 (for example, S111 to S123 in FIGS. 3, S111 to S123A in FIGS. 4, and S111A to S123 in FIG. 5).

Therefore, even when the battery 101 is connected to the charging device 250 after being removed from the electrified vehicle 100, the charging of the battery 101 is not started until the specific time elapses. As a result, degradation of the battery 101 can be suppressed.

(2) As shown in FIG. 2, the specific time may be a time until high-rate degradation is eliminated, namely until the battery 101 is no longer in the state in which the battery 101 has an increased internal resistance due to an uneven lithium-ion concentration distribution in an electrolyte solution of the battery 101 caused by charging or discharging including charging or discharging performed at a current value higher than the predetermined current value when the battery 101 is connected to the electrified vehicle 100.

Accordingly, the battery 101 may be connected to the charging device 250 after being removed from the electrified vehicle 100. Even in this case, the charging of the battery 101 is not started until the time it takes for the high-rate degradation to be eliminated elapses, namely until the battery 101 is no longer in the state in which the battery 101 has an increased internal resistance due to an uneven lithium-ion concentration distribution in the electrolyte solution of the battery 101 caused by charging or discharging including charging or discharging performed at a current value higher than the predetermined current value when the battery 101 is connected to the electrified vehicle 100. As a result, degradation of the battery 101 caused by high-rate degradation can be reduced.

(3) As shown in FIGS. 3 to 5, even if the battery 101 is connected, the charging device 250 may not initiate charging of the battery 101 until the specific time elapses (for example, S111 to S123 in FIGS. 3, S111 to S123A in FIGS. 4, and S111A to S123 in FIG. 5).

Accordingly, the battery 101 may be connected to the charging device 250 after being removed from the electrified vehicle 100. Even in this case, the charging device 250 does not start charging the battery 101 until the specific time elapses. As a result, degradation of the battery 101 can be suppressed by the charging device 250.

(4) As shown in FIG. 2, the battery 101 may include a timer configured to measure the remaining time left until the specific time elapses. As shown in FIGS. 3 and 5, the charging of the battery may not be started until the remaining time measured by the timer 23 becomes less than a predetermined time (for example, 0) (for example, S111 to S123 in FIG. 3, S111A to S123 in FIG. 5).

Accordingly, the battery 101 may be connected to the charging device 250 after being removed from the electrified vehicle 100. Even in this case, charging of the battery 101 is not started until the remaining time left until the specific time elapses as measured by the timer 23 becomes less than a predetermined time (for example, it may be 0 or another value such as a relatively small value). As a result, degradation of the battery 101 can be suppressed by the timer 23.

(5) As shown in FIGS. 1 and 2, electrified vehicle 100 is a vehicle capable of mounting the battery 101. As shown in FIGS. 1 and 2, a communication device 17 is provided for transmitting the remaining time measured by the timer 23 to a server capable of communicating with the charging device 250 for charging the battery 101 removed from electrified vehicle 100. The server may be, for example, the charging device 250 itself or another server.

Accordingly, it is possible to provide an electrified vehicle 100 capable of suppressing degradation of the battery 101.

(6) As shown in FIGS. 1 and 2, the charging device 250 is a device that charges a swappable battery 101 for driving an electrified vehicle 100. As shown in FIGS. 3 to 5, the charging of the battery 101 is not started until a specific time (for example, elimination time, certain time) elapses from when the battery 101 is connected to the charging device 250 after being removed from the electrified vehicle 100 (for example, from S111 to S123 in FIG. 3, from S111 to S123A in FIG. 4, S123 from S111A in FIG. 5).

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. A battery that is swappable and that is configured to drive a vehicle, wherein charging of the battery is not started until a specific time elapses from when the battery is connected to a charging device after being removed from the vehicle.

2. The battery according to claim 1, wherein the specific time is a time until high-rate degradation is eliminated, the high-rate degradation being a state in which the battery has an increased internal resistance due to an uneven lithium-ion concentration distribution in an electrolyte solution of the battery caused by charging or discharging including charging or discharging performed at a current value higher than a predetermined current value when the battery is connected to the vehicle.

3. The battery according to claim 1, wherein the charging device is configured not to start the charging of the battery until the specific time elapses, even when the battery is connected to the charging device.

4. The battery according to claim 1, comprising a timer configured to measure a remaining time left until the specific time elapses,
wherein the charging of the battery is not started until the remaining time measured by the timer becomes less than a predetermined time.

5. A vehicle on which the battery according to claim 4 is mountable, the vehicle comprising a communication unit configured to send the remaining time measured by the timer to a server, the server being configured to communicate with the charging device configured to charge the battery removed from the vehicle.
